(19) United States
(12) Patent Application Publication
(10) Pub. No.: US 2016/0195231 A1
(43) Pub. Date: Jul. 7, 2016

(54) LIGHTING ARRANGEMENT

(71) Applicant: OSRAM OPTO SEMICONDUCTORS GMBH, Regensburg (DE)

(72) Inventor: Stefan Grötsch, Bad Abbach/Lengfeld (DE)

(21) Appl. No.: 14/909,554

(22) PCT Filed: Jul. 31, 2014
(86) PCT No.: PCT/EP2014/066463

§ 371 Date: Feb. 2, 2016

(30) Foreign Application Priority Data
Aug. 5, 2013 (DE) 10 2013 215 374.0

(51) Int. Cl. F21S 8/10

(52) U.S. Cl. CPC F21S 48/1145; F21S 48/115; F21S 48/1225; F21S 48/1731; F21S 48/1757; F21S 48/1241; F21S 48/114; F21S 48/125; F21Y 2101/02; F21Y 2101/025

(57) ABSTRACT

A lighting arrangement includes a light source, a taper, and a two-dimensional image generator, wherein the taper guides light from the light source to the two-dimensional image generator, and the lighting arrangement is configured as a motor vehicle headlamp.

### TECHNICAL FIELD

This disclosure relates to a lighting arrangement.

### BACKGROUND

It is known to equip motor vehicles with front headlamps, the light from which is adapted to a respective driving situation of the motor vehicle. Such systems are also referred to as adaptive front lighting systems or as active forward lighting (AFS). Such headlamps may, for example, have mobile lenses to achieve improved lighting of a bend while driving around a bend. It is likewise known to configure such headlamps with a multiplicity of discretely driven light-emitting diode components that can be individually switched on and off according to the geometry of the desired lighting.

It could nonetheless be helpful to provide improved lighting arrangements.

### SUMMARY

I provide a lighting arrangement including a light source, a taper, and a two-dimensional image generator, wherein the taper guides light from the light source to the two-dimensional image generator, and the lighting arrangement is configured as a motor vehicle headlamp.

### BRIEF DESCRIPTION OF THE DRAWINGS

FIG. 1 shows a view of a first lighting arrangement.

FIG. 2 shows a view of a laser diode light source of a lighting arrangement.

FIG. 3 shows a view of a light-emitting diode light source of a lighting arrangement.

FIG. 4 shows a view of a second lighting arrangement.

FIG. 5 shows a view of a third lighting arrangement.

### LIST OF REFERENCES

10 first lighting arrangement
20 second lighting arrangement
30 third lighting arrangement
100 light source
110 first beam direction
200 taper
210 input side
220 output side
300 retardation plate
400 polarization-dependently reflecting sheet
500 first two-dimensional image generator
600 optical projection element
700 polarization beam splitter
710 splitter plane
720 second beam direction
800 prism
810 interface
820 second beam direction
1100 laser diode light source
1110 laser diode
1120 optical element
1130 diaphragm
1140 diaphragm opening
1150 mirroring
1160 converter
2100 light-emitting diode light source
2110 light-emitting diode
2120 converter
1500 second two-dimensional image generator
2500 third two-dimensional image generator

### DETAILED DESCRIPTION

My lighting arrangement comprises a light source, a taper and a two-dimensional image generator. The taper is intended to guide light from the light source to the two-dimensional image generator. Advantageously, the two-dimensional image generator of the lighting arrangement may generate a spatial light field with variable geometry from light generated by the light source. The two-dimensional image generator in this case allows great variability and accurate adjustability of the geometry of the light field being generated. No modification of the light source is required to vary the light field generated by the lighting arrangement. This makes it possible to configure the light source as an economic or high-power point or surface light source.

The light source may comprise a laser diode. Advantageously, the light source of the lighting arrangement may thereby be configured to generate a high luminous flux. In this case, the light source can have compact dimensions and be inexpensively producible.

The light source may comprise a light-emitting diode. Advantageously, the light source may thereby also be configured to generate a high luminous flux, have compact dimensions and be inexpensively producible.

A diaphragm may be arranged between the light source and the taper. In this case, a side of the diaphragm facing toward the taper has mirroring. In this way, light scattered back or reflected in the lighting arrangement in the direction of the light source can be reflected again at the mirroring of the diaphragm and thereby be delivered for use. Advantageously, brightness losses in the lighting arrangement due to light reflected or scattered back in the direction of the light source can thereby be reduced or eliminated. In this way, the lighting arrangement can advantageously be configured with a high efficiency and to use a high optical power.

The lighting arrangement may comprise a converter material that converts a wavelength of electromagnetic radiation. In this case, the converter material may, for example, be configured to absorb electromagnetic radiation with a first wavelength and emit electromagnetic radiation with a second, typically longer, wavelength. In particular, the converter material may be configured to at least partially absorb electromagnetic radiation (for example, visible light) emitted by the light source of the lighting arrangement and convert it into electromagnetic radiation with a different wavelength. The converter material of the lighting arrangement is therefore suitable for modifying a light color of light generated by the light source of the lighting arrangement. The light source of the lighting arrangement may, for example, be configured to emit electromagnetic radiation with a wavelength in the blue spectral range. The converter material of the lighting arrangement may be configured to convert this electromagnetic radiation into white light.

A polarization-dependently reflecting sheet may be arranged in the optical beam path of the lighting arrangement between the taper and the two-dimensional image generator. The polarization-dependently reflecting sheet may thus be configured so that light with a first polarization direction can pass through the sheet, while light with a second polarization direction is reflected by the sheet. Light passing through the sheet may have an essentially uniform polarization direction. Light reflected at the polarization-dependently reflecting sheet may return to the converter material, be scattered and/or reabsorbed there, and subsequently with a certain likelihood reach the polarization-dependently reflecting sheet with a polarization direction that allows transmission through the polarization-dependently reflecting sheet. Advantageously, more than half of the light striking the polarization-dependently reflecting sheet can pass through the polarization-dependently reflecting sheet and, after passing through the sheet, has an essentially uniform polarization direction. The polarization direction may, for example, be matched to a preferred polarization direction of the two-dimensional image generator.

A retardation plate may be arranged in the optical beam path of the lighting arrangement between the taper and the polarization-dependently reflecting sheet. The retardation plate may also be referred to as an optical retarder. The retardation plate may be configured to rotate a polarization of light passing through the retardation plate by 45°. The fraction of this light transmitted at the polarization dependently reflecting sheet is essentially not changed thereby. Light reaching the polarization-dependently reflecting sheet from the light source of the lighting arrangement for the first time with randomly distributed polarization directions then experiences a rotation of its polarization by 45° when passing through the retardation plate for the first time. The fraction of this light transmitted at the polarization-dependently reflecting sheet is essentially not changed thereby. Light reflected at the polarization-dependently reflecting sheet passes through the retardation plate once more and may, for example, be reflected in the light source or at the mirroring of the diaphragm, whereupon it passes through the retardation plate for a third time before it reaches the polarization-dependently reflecting sheet again. By the twofold further passage through the retardation plate, the polarization direction of this light has now been rotated by 90° so that this time it can pass through the polarization-dependently reflecting sheet. Advantageously, a fraction of the light in total passing through the polarization-dependently reflecting sheet can also be increased in this way so that a high efficiency of the lighting arrangement is obtained.

The two-dimensional image generator may be configured as a liquid-crystal arrangement. In this case, the liquid-crystal arrangement can be configured as a two-dimensional pixel matrix. Advantageously, the two-dimensional image generator may therefore generate, from the light generated by the light source of the lighting arrangement, a two-dimensional light field with a geometry predeterminable by the pixel matrix of the liquid-crystal arrangement.

The two-dimensional image generator may be configured as a monochromatic, i.e. non color-selective, liquid-crystal arrangement. In this way, the liquid-crystal arrangement does not need to have separate cells for different light colors. This advantageously reduces light losses in the liquid-crystal arrangement of the two-dimensional image generator. Furthermore, the two-dimensional image generator is therefore producible inexpensively.

The two-dimensional image generator may be configured as a transparent liquid-crystal arrangement. The two-dimensional image generator may then also be referred to as an LCD. The transparency of the two-dimensional image generator is in this case advantageously adjustable so that the light passing through the two-dimensional image generator configured as a transparent liquid-crystal arrangement can be modulated two-dimensionally.

The two-dimensional image generator may be configured as a reflecting liquid-crystal arrangement. The two-dimensional image generator may then also be referred to as an LCOS. The two-dimensional image generator then makes it possible to two-dimensionally modulate a polarization direction of light reflected at the two-dimensional image generator. At each pixel of the pixel matrix of the two-dimensional image generator configured as a reflecting liquid-crystal arrangement, a polarization direction of light being reflected can then selectively be either rotated or not rotated.

A polarization beam splitter may be arranged in the optical beam path of the lighting arrangement between the taper and the two-dimensional image generator. Advantageously, a beam can be split polarization-dependently by the polarization beam splitter. This makes it possible to remove, from light reflected at the two-dimensional image generator configured as a reflecting liquid-crystal arrangement, those fractions whose polarization has not been rotated by the two-dimensional image generator configured as a reflecting liquid-crystal arrangement. This makes it possible for the two-dimensional image generator to two-dimensionally modulate light emerging from the polarization beam splitter.

The two-dimensional image generator may be configured as a micromirror arrangement. The micromirror arrangement may also be referred to as a digital micromirror device (DMD). The two-dimensional image generator configured as a micromirror arrangement may have a two-dimensional array of micromechanical mirrors. Each of the micromechanical mirrors makes it possible for light striking the two-dimensional image generator configured as a micromirror arrangement to be reflected in an adjustable direction. This makes it possible to two-dimensionally modulate light reflected at the two-dimensional image generator configured as a micromirror arrangement.

A prism may be arranged in the optical beam path of the lighting arrangement between the taper and the two-dimensional image generator. The prism of the lighting arrangement may advantageously be used to deviate light generated by the light source of the lighting arrangement and guided to the prism by the taper of the lighting arrangement onto the two-dimensional image generator configured as a micromirror arrangement and to forward light reflected by the two-dimensional image generator configured as a micromirror arrangement inside the lighting arrangement. To this end, the prism may have an interface which either totally reflects or transmits light striking the interface, depending on an angle of incidence.

The lighting arrangement may comprise an optical projection element arranged downstream of the two-dimensional image generator in the optical beam path of the lighting arrangement. The optical projection element may comprise a projection lens, for example. The optical projection element of the lighting arrangement may be used to project light generated by the lighting arrangement and modulated two-dimensionally into a spatial region to be illuminated by the lighting arrangement.

The lighting arrangement may be configured as a headlamp for a motor vehicle. Advantageously, the lighting arrangement allows illumination of a variable part of an environment of the motor vehicle.

The two-dimensional image generator may have a higher resolution in a first spatial direction than in a second spatial direction. For example, the two-dimensional image generator may have a higher resolution in the vertical direction than in the horizontal direction, for example, with a resolution which is at least two times or, preferably, at least three times as high. This has the advantage that the lighting arrangement allows a finer variation of the illumination generated by the lighting arrangement in the vertical direction than in the horizontal direction. If the lighting arrangement is configured as a headlamp for a motor vehicle, this allows particularly fine variation of the emitted light in the height and distance directions.

The two-dimensional image generator may comprise image points of different size. For example, image points in a central region of the image generator may have a smaller size and therefore be arranged more densely next to one another than in an outer region of the two-dimensional image generator. This has the advantage that the lighting arrangement allows a finer variation in the central region of the illumination generated by the lighting arrangement than in the outer region of the illumination generated by the lighting arrangement. If the lighting arrangement is configured as a headlamp for a motor vehicle, this allows a particularly fine variation of the emitted light in the particularly important central region of the light cone.

The above-described properties, features and advantages, as well as the way in which they are achieved, will become more clearly and comprehensively understandable in connection with the following description of examples, which will be explained in more detail in connection with the drawings.

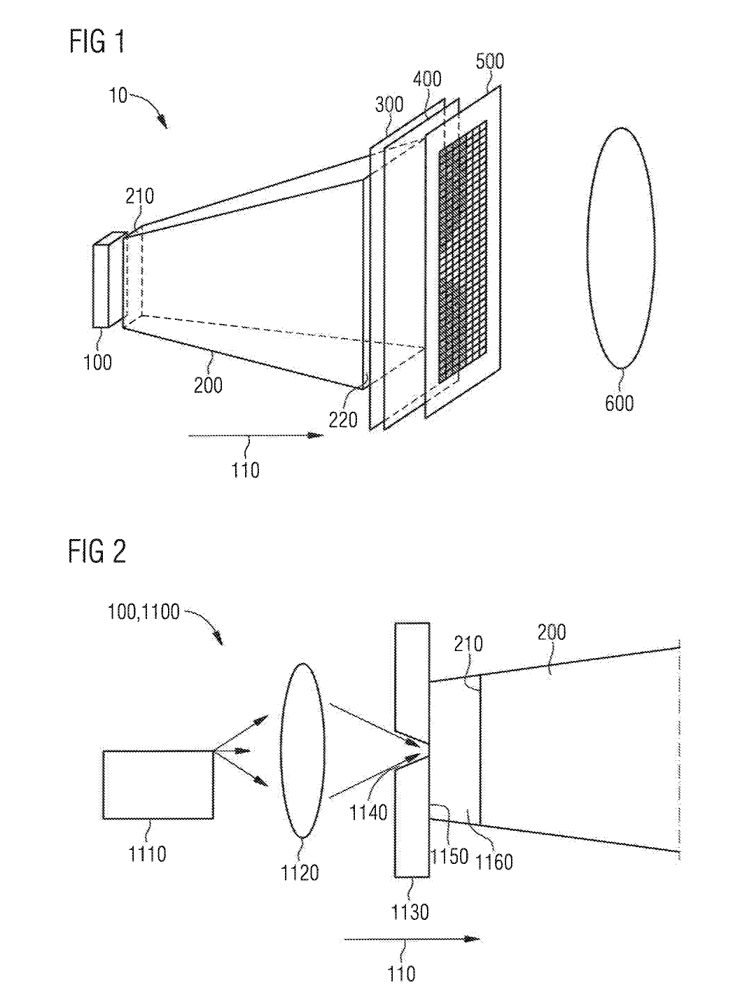

FIG. 1 shows a highly schematized view of a first lighting arrangement 10. The first lighting arrangement 10 may, for example, serve as a headlamp, in particular as a front headlamp, of a motor vehicle. The first lighting arrangement 10 allows adaptive illumination of an environment of the motor vehicle which may, for example, be adaptable to a driving situation of the motor vehicle. Adaptation of the illumination may, for example, comprise a horizontal and/or vertical displacement and/or a size change and/or shape change of a region illuminated by the first lighting arrangement 10 in the environment of the motor vehicle. Adaptation of the illumination may, for example, be carried out as a function of the driving speed of the motor vehicle, driving the motor vehicle around a bend, a pitch or roll movement of the motor vehicle, a type of road on which the motor vehicle is being driven, as a function of the presence of other oncoming or preceding vehicles, and/or as a function of a brightness of ambient light.

The first lighting arrangement 10 has a light source 100. The light source 100 generates visible light. Preferably, the light source 100 is configured to generate visible light with a white light color comprising electromagnetic radiation with different wavelengths. Light generated by the light source 100 of the first lighting arrangement 10 leaves the light source 100 essentially in a first beam direction 110.

The first lighting arrangement 10 has an optical taper 200 arranged downstream of the first light source 100 such that light emerging from the light source 100 in the first beam direction 110 reaches the taper 200. The taper 200 may be configured as a fiber-optic component. The taper 200 has an input side 210 facing toward the light source 100 and an output side 220 facing away from the light source 100. At its output side 220, the taper 200 has a larger diameter than at its input side 210. Between its input side 210 and its output side 220, the taper 200 therefore widens frustopyramidally or frustoconically.

The taper 200 is used to guide light generated by the light source 100 from the input side 210 to the output side 220 of the taper 200 and to emit it at the output side 220. Furthermore, the taper 200 is used to reduce beam divergence of the light emitted at the output side 220 of the taper 200 relative to beam divergence of the light generated by the light source 100 and input into the taper 200 at the input side 210 of the taper 200. This may be done by reflection at the lateral surfaces of the taper 200, for example, by total internal reflection or by reflection at a reflective coating of the lateral surfaces of the taper 200. The light generated by the light source 100 and input into the taper 200 at the input side 210 of the taper 200 may, for example, have a divergence of +/−90°. Light output at the output side 220 of the taper 200 may, for example, have a divergence of +/−10°.

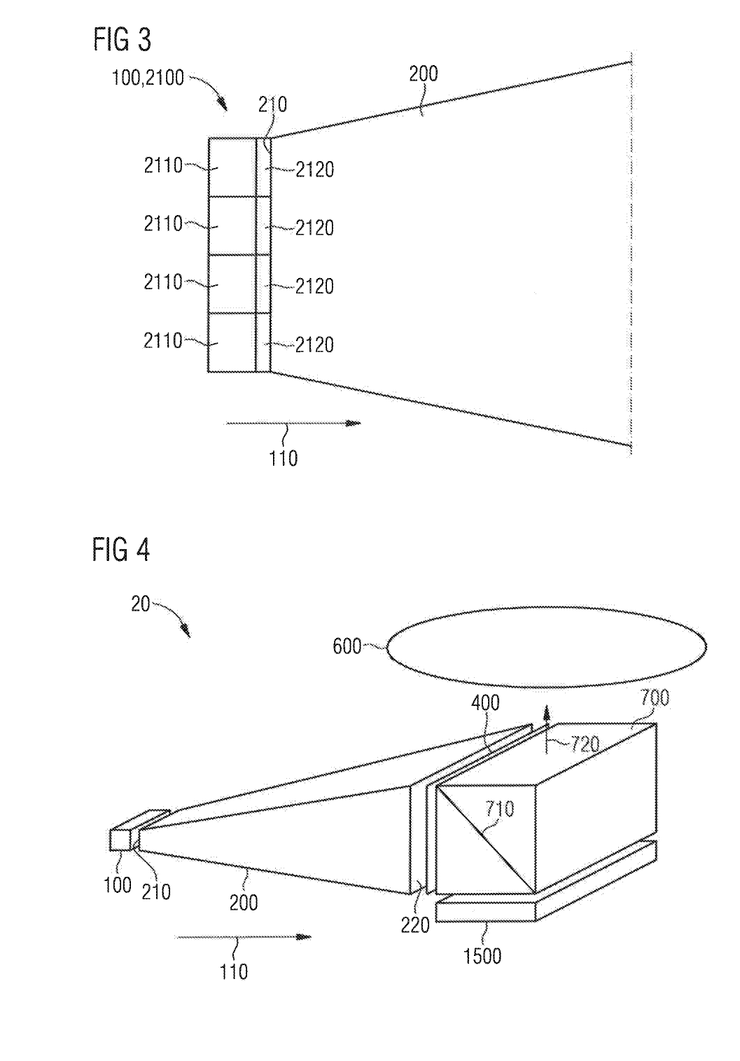

The light source 100 of the first lighting arrangement 10 may, for example, have one or more optoelectronic semiconductor chips intended to emit light. FIGS. 2 and 3 show possible configurations of the light source 100.

FIG. 2 shows a schematic representation of a laser diode light source 1100. The laser diode light source 1100 has a laser diode 1110. The laser diode 1110 may, in particular, be a semiconductor laser diode. The laser diode 1110 is configured to generate a light beam. For example, the laser diode 1110 may be configured to generate a light beam with a wavelength in the blue spectral range.

The laser diode light source 1110 furthermore has a diaphragm 1130 with a diaphragm opening 1140. The diaphragm opening 1140 may also be referred to as an aperture. The diaphragm opening 1140 may, for example, be configured in the shape of a circular disk. Arranged between the laser diode 1110 and the diaphragm 1130, there is an optical element 1120 intended to project a laser beam emitted by the laser diode 1110 into the diaphragm opening 1140. The optical element 1120 may, for example, have a converging lens. As an alternative, the laser diode 1110 can also be arranged so close to the diaphragm 1130 that the laser beam emitted by the laser diode 1110 enters the diaphragm opening 1140 directly. In this case, the optical element 1120 may be omitted.

The diaphragm 1130 may be configured as a cooling plate or be thermally conductively connected to a suitable cooling device to dissipate heat formed in the diaphragm 1130.

The laser diode light source 1100 can also comprise more than one laser diode 1110. In this case, the diaphragm 1130 may have one diaphragm opening 1140 per laser diode 1110. As an alternative, the laser beams of all the laser diodes 1110 can be projected into a common diaphragm opening 1140. To this end, the diaphragm opening 1140 can also be configured as an elongate slit.

A converter 1160 is arranged between a side of the diaphragm 1130 facing away from the laser diode 1110 and the input side 210 of the taper 200. Laser light from the laser diode 1110 passing through the diaphragm opening 1140 of the diaphragm 1130 therefore strikes the converter 1160. The converter 1160 is configured to absorb at least a part of the laser light from the laser diode 1110 striking the converter 1160 and in turn to emit light with a different, typically longer, wavelength. A mixture of light emitted by the laser diode 1110 and not absorbed by the converter 1160 with light emitted by the converter 1160 may, for example, have a white light color. The converter 1160 may, for example, have a luminescent material, for instance an organic or inorganic luminescent material. The converter 1160 may also have quantum dots.

Light emerging from the converter 1160 can enter the taper 200 at the input side 210 of the taper 200. Light leaving the converter 1160 may have a large beam divergence and a randomly distributed polarization.

Mirroring 1150 is preferably arranged on the side of the diaphragm 1130 facing toward the converter 1160. The mirroring 1150 may be used to reflect light emerging in the direction of the diaphragm 1130 from the converter 1160 in the direction of the taper 200. The mirroring 1150 may also be used to reflect light scattered back in the direction of the diaphragm 1130 from the taper 200 back to the taper 200. The diaphragm opening 1140 of the diaphragm 1130 preferably has a much smaller cross-sectional area than the input side 210 of the taper 200. In this way, light losses due to light scattered back in the direction of the diaphragm 1130 are kept small.

FIG. 3 shows a schematic representation of a light-emitting diode light source 2100. The light-emitting diode light source 2100 has a multiplicity of light-emitting diodes 2110, which in the example represented are arranged as a two-dimensional array close to the input side 210 of the taper 200. The light-emitting diodes 2110 can, however, also be arranged in a different way. It is also possible to configure the light-emitting diode light source 2100 with only a single light-emitting diode 2110.

The light-emitting diodes 2110 are configured to emit electromagnetic radiation, for example, visible light with a wavelength in the blue spectral range. Each light-emitting diode 2110 has, on its side facing toward the input side 210 of the taper 200, a converter 2120 configured to convert a light color of the electromagnetic radiation emitted by the light-emitting diode 2110. For example, the converter 2120 may be configured to generate white light from the electromagnetic radiation emitted by the light-emitting diode 2110. To this end, the converter 2120 may absorb a part of the electromagnetic radiation emitted by the light-emitting diode 2110 and in turn emit electromagnetic radiation with a different wavelength. The converter 2120 may also be configured in a similar way to the converter 1160 of the laser diode light source 1100 of FIG. 2.

Light emerging from the converter 2120 can enter the taper 200 at the input side 210 of the taper 200. The light leaving the converter 2120 may have a large beam divergence and a randomly distributed polarization direction.

A surface, facing toward the converter 2120, of each light-emitting diode 2110 of the light-emitting diode light source 2100 may at least in sections be configured to be optically reflective.

The first lighting arrangement 10, schematically represented in FIG. 1, has a first two-dimensional image generator 500. The first two-dimensional image generator 500 is configured as a transparent liquid-crystal arrangement. The first two-dimensional image generator 500 may also be referred to as an LCD. Preferably, the first two-dimensional image generator 500 is configured as a monochromatic transparent liquid-crystal arrangement. In this case, the first two-dimensional image generator 500 only has one type of liquid-crystal cell, and not separate liquid-crystal cells for different light colors. In this way, the first two-dimensional image generator 500 configured as a monochromatic transparent liquid-crystal arrangement can have a high transmission.

The first two-dimensional image generator 500 has a two-dimensional array of liquid-crystal cells, which form a pixel matrix. The pixels, formed by the liquid-crystal cells, of the first two-dimensional image generator 500 may also be referred to as image points. The pixel matrix of the first two-dimensional image generator 500 is arranged perpendicularly to the first beam direction 110 and parallel to the output side 220 of the taper 200.

Each image point of the first two-dimensional image generator 500 can be adjusted, independently of the other image points such that light from the taper 200, with a predetermined polarization direction, striking the respective image point of the first two-dimensional image generator 500 can either pass through the relevant image point of the first two-dimensional image generator or is absorbed. To this end, for example, the first two-dimensional image generator 500 may have two polarization filters arranged on either side of the first two-dimensional image generator 500, which are rotated by 90° relative to one another. Each image point of the first two-dimensional image generator 500 can then adjustably rotate a polarization direction of light passing through the image point by 90°, or not rotate it.

Independently of the adjustable transmission of the individual image points of the first two-dimensional image generator 500 configured as a transparent liquid-crystal arrangement, only light with a predetermined polarization direction can pass through the first two-dimensional image generator 500. In the first lighting arrangement 10, therefore, a polarization-dependently reflecting sheet 400 is arranged between the output side 220 of the taper 200 and the first two-dimensional image generator 500. The polarization-dependently reflecting sheet 400 is oriented perpendicularly to the first beam direction 110. The polarization-dependently reflecting sheet 400 is configured either to reflect or transmit light striking the polarization-dependently reflecting sheet 400 as a function of the polarization direction of the light. In this case, the polarization-dependently reflecting sheet 400 is oriented such that the polarization direction of the light passing through the polarization-dependently reflecting sheet 400 corresponds to the polarization direction which can also pass through the first two-dimensional image generator 500. The polarization-dependently reflecting sheet 400 may also be referred to as a film and may, for example, be configured as an inorganic film.

Light, with the polarization direction not suitable for the first two-dimensional image generator 500, reflected at the polarization-dependently reflecting sheet 400, returns to the taper 200, passes through the latter from the output side 220 to the input side 210, and can be at least partially absorbed in the converter 1160, 2120 of the light source 100 and re-emitted with a sometimes modified polarization direction. The re-emitted light in turn passes through the taper 200 to the polarization-dependently reflecting sheet 400 where it has another opportunity to pass through the polarization-dependently reflecting sheet 400 and reach the first two-dimensional image generator 500. The polarization-dependently reflecting sheet 400 thus increases the fraction of the light generated by the light source 100 which reaches the first two-dimensional image generator 500 with the polarization direction suitable for the first two-dimensional image generator 500.

In the first lighting arrangement 10, a retardation plate 300 is arranged between the output side 220 of the taper 200 and the polarization-dependently reflecting sheet 400. The retardation plate 300 may also be referred to as an optical retarder. The retardation plate 300 is oriented perpendicularly to the first beam direction 110 and therefore parallel to the output side 220 of the taper 200 and to the polarization-dependently reflecting sheet 400.

The retardation plate 300 is configured to rotate a polarization direction of light passing through the retardation plate 300 by 45°. In this way, the retardation plate 300 can further increase the fraction of the light generated by the light source 100 of the first lighting arrangement 10 which reaches the first two-dimensional image generator 500 with the polarization direction suitable for the first two-dimensional image generator 500.

During the first pass through the retardation plate 300, light generated by the light source 100 experiences a rotation of its polarization direction by 45°. Since the polarization directions of the light emerging from the light source 100 are essentially distributed randomly, the size of the fraction of the light which can pass through the polarization-dependently reflecting sheet 400 is essentially not changed thereby.

The fraction of the light reflected at the polarization-dependently reflecting sheet 400 passes through the retardation plate 300 once more and experiences a further rotation of its polarization direction by 45°. The light reflected at the polarization-dependently reflecting sheet 400 passes back through the taper 200 to the light source 100. If it is not absorbed there in the converter 1160, 2120, the light can be reflected at the mirroring 1150 of the diaphragm 1130 of the laser diode light source 1100 or at the upper side of the light-emitting diodes 2110 of the light-emitting diode light source 2100, without the polarization direction thereby being changed. The light reflected in this way passes once more through the taper 200 and the retardation plate 300, and during this it experiences a further rotation of its polarization direction by 45°. Since the polarization direction of this light has now been rotated by 90° relative to the last time it struck the polarization-dependently reflecting sheet 400, the light can this time pass through the polarization-dependently reflecting sheet 400 and reach the first two-dimensional image generator 500 with the polarization direction suitable for the first two-dimensional image generator 500.

The polarization-dependently reflecting sheet 400 and the retardation plate 300 can therefore increase the fraction of the light generated by the light source 100, which reaches the first two-dimensional image generator 500 with the polarization direction suitable for the first two-dimensional image generator 500, to more than 50%. The retardation plate 300 may, however, also be omitted. The polarization-dependently reflecting sheet 400 may also be omitted.

The first two-dimensional image generator 500 transmits only a part of the light striking the first two-dimensional image generator 500. In this case, for each image point of the two-dimensional image generator 500, it is possible to adjust individually whether light striking the respective image point can pass through the first two-dimensional image generator 500. The first two-dimensional image generator 500 thus induces two-dimensional modulation of the light distribution.

The first lighting arrangement 10 has an optical projection element 600 arranged downstream of the first two-dimensional image generator 500 in the optical beam path of the first lighting arrangement 10. The optical projection element 600 may, for example, comprise a projection lens and/or one or more mirrors. The optical projection element 600 is configured to project light which has passed through the first two-dimensional image generator 500 and is two-dimensionally modulated into a spatial region to be illuminated by the first lighting arrangement 10. For example, the optical projection element 600 may be configured to project the light modulated by the first two-dimensional image generator 500 onto a road in front of a motor vehicle. In a simplified configuration of the first lighting arrangement 10, the optical projection element 600 may be omitted.

Taking into account all losses incurred in the first lighting arrangement 10, for example, from 20% to 25% of the luminous flux generated by the light source 100 can be projected onto the road.

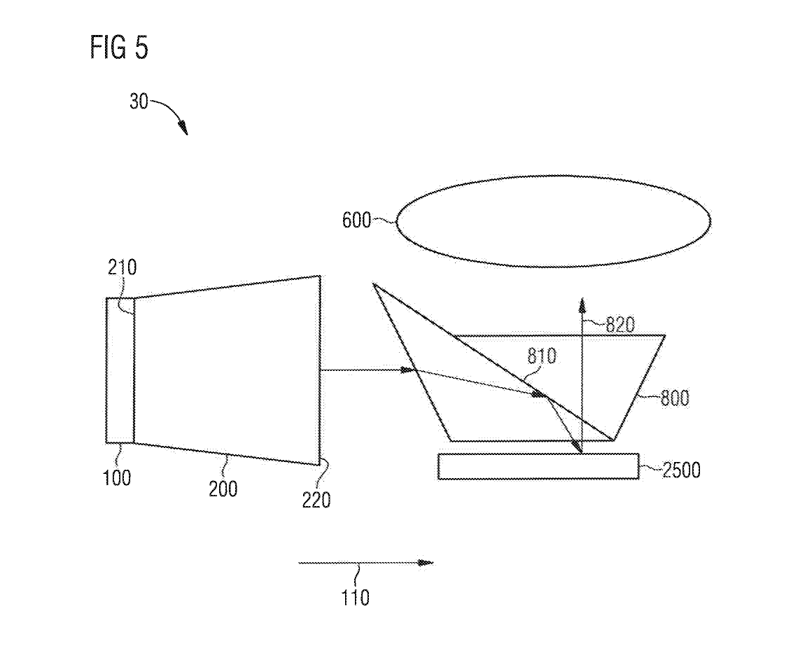

FIG. 4 shows a schematic representation of a second lighting arrangement 20. The second lighting arrangement 20 has correspondences with the first lighting arrangement 10 of FIG. 1. Component parts of the first lighting arrangement 10 which are also present in the second lighting arrangement 20 are provided with the same references in FIG. 4 as in FIG. 1 and will not be described again in detail below. In what follows, only the differences between the second lighting arrangement 20 and the first lighting arrangement 10 will be explained.

The second lighting arrangement 20 has a light source 100 that emits light in a first beam direction 110, inputs it at an input side 210 into a taper 200, and transports it to an output side 220. The light source 100 may, for example, be configured in a similar way to the laser diode light source 1100 of FIG. 2 or the light-emitting diode light source 2100 of FIG. 3.

In the optical beam path of the second lighting arrangement 20, following the output side 220 of the taper 200, the second lighting arrangement 20 has a polarization-dependently reflecting sheet 400. There is no retardation plate 300 in the second lighting arrangement 20 represented by way of example in FIG. 4, although there can be one between the output side 220 of the taper 200 and the polarization-dependently reflecting sheet 400. As an alternative, besides the retardation plate 300, the polarization-dependently reflecting sheet 400 can also be omitted from the second lighting arrangement 20.

Instead of the first two-dimensional image generator 500, in the second lighting arrangement 20 a second two-dimensional image generator 1500 is provided. The second two-dimensional image generator 1500 is configured as a reflecting liquid-crystal arrangement, preferably as a monochromatic reflecting liquid-crystal arrangement. The second two-dimensional image generator 1500 configured as a reflecting liquid-crystal arrangement may also be referred to as an LCoS display.

The second two-dimensional image generator 1500 has a two-dimensional array of optically reflecting liquid-crystal cells, which form a matrix of pixels or image points. For each image point of the second two-dimensional image generator 1500, it is possible to adjust individually whether or not a polarization direction of light reflected at the respective image point is to be rotated by 90°.

The second two-dimensional image generator 1500 is oriented parallel to the first beam direction 110, i.e. perpendicularly to the output side 220 of the taper 200.

A polarization beam splitter 700 is arranged in the optical beam path of the second lighting arrangement 20 between the output side 220 of the taper 200 and the second two-dimensional image generator 1500. The polarization beam splitter 700 has a splitter plane 710, at which light reaching the splitter plane 710 in the first beam direction 110 from the output side 220 of the taper 200 is deviated perpendicularly in the direction of the second two-dimensional image generator 1500.

The light reaching the second two-dimensional image generator 1500 is reflected at the image points of the second two-dimensional image generator 1500, a polarization direction of the reflected light either being rotated by 90° or remaining unchanged as a function of the settings of the individual image points.

The light reflected by the second two-dimensional image generator 1500 in a second beam direction 720 again strikes the splitter plane 710 of the polarization beam splitter. Those fractions of the light striking the splitter plane 710 of the polarization beam splitter 700 again whose polarization direction has not been rotated during the reflection at the second two-dimensional image generator 1500 are reflected again at the splitter plane 710 of the polarization beam splitter 700 and are therefore deviated perpendicularly in the direction of the output side 220 of the taper 200. Those fractions of the light reflected at the second two-dimensional image generator 1500 whose polarization direction has been rotated during the reflection at the second two-dimensional image generator 1500, however, are deviated again by the polarization beam splitter 700 and emerge from the polarization beam splitter 700 in the second beam direction 720 oriented perpendicularly to the first beam direction 110.

The light not deviated during the second passage through the polarization beam splitter 700 and emerging from the polarization beam splitter 700 in the second beam direction 720 is two-dimensionally modulated by the image points of the second two-dimensional image generator 1500. By an optical projection element 600, which follows the polarization beam splitter 700 in the second beam direction 720, the two-dimensionally modulated light can be deviated into a space to be illuminated by the second lighting arrangement 20, for example, onto a road in front of a motor vehicle.

That part of the light reflected at the second two-dimensional image generator 1500 reflected back into the taper 200 during the second passage through the polarization beam splitter 700 is mixed homogeneously inside the taper 200, i.e. it has its two-dimensional modulation induced by the second two-dimensional image generator 1500 removed. The light travels via the input side 210 to the light source 100 of the second lighting arrangement 20, where it can be reflected or reabsorbed and emitted again. Reabsorption and re-emission may, for example, take place in the converter 1160, 2120. Reflection may, for example, take place at the mirroring 1150 of the diaphragm 1130 or at the reflective surface of the light-emitting diodes 2110. The reflected or re-emitted light subsequently travels again to the input side 210 of the taper 200 and is guided again to the second two-dimensional image generator 1500 by the taper 200.

In the second lighting arrangement 20, therefore, at least a part of the unrequired light of switched-off image points of the second two-dimensional image generator 1500 is recovered and sent to the second two-dimensional image generator 1500 again. In this way, the second lighting arrangement 20 can have a particularly high efficiency.

To prevent a luminous density of light projected by the second lighting arrangement 20 into an environment to be illuminated from varying with the number of active image points of the second two-dimensional image generator 1500, the light source 100 of the second lighting arrangement 20 may be regulated as a function of the number of active, i.e. switched-on, image points of the second two-dimensional image generator 1500. In this case, for example, the brightness and color locus of the light source 100 may be separately corrected by varying the PWM frequency and the operating current.

FIG. 5 shows a schematic representation of a third lighting arrangement 30. The third lighting arrangement 30 has correspondences with the first lighting arrangement 10 of FIG. 1. Component parts of the first lighting arrangement 10 also present in the third lighting arrangement 30 are provided with the same references in FIG. 5 as in FIG. 1 and will not be described again in detail below. In what follows, only the differences between the third lighting arrangement 30 and the first lighting arrangement 10 will be explained.

The third lighting arrangement 30 also has a light source 100 that emits light in a first beam direction 110. The light source 100 may, for example, be configured in a way similar to the laser diode light source 1100 of FIG. 2 or the light-emitting diode light source 2100 of FIG. 3. Light emitted by the light source 100 in the first beam direction 110 enters a taper 200 at an input side 210 and is guided thereby to an output side 220. The retardation plate 300 and the polarization-dependently reflecting sheet 400 are preferably omitted from the third lighting arrangement 30.

Instead of the first two-dimensional image generator 500, the third lighting arrangement 30 has a third two-dimensional image generator 2500. The third two-dimensional image generator 2500 is configured as a micromirror arrangement. The third two-dimensional image generator 2500 configured as a micromirror arrangement has a two-dimensional array of micromechanical mirrors, which form a matrix of pixels or image points. Each micromechanical micromirror can be adjusted independently of the other micromirrors to reflect light striking the respective micromirror in one of at least two different spatial directions.

The two-dimensional array of micromirrors of the third two-dimensional image generator 2500, configured as a micromirror arrangement, of the third lighting arrangement 30 is oriented parallel to the first beam direction 110 and therefore perpendicularly to the output side 220 of the taper 200.

A prism 800 is arranged in the optical beam path of the third lighting arrangement 30 between the output side 220 of the taper 200 and the third two-dimensional image generator 2500. The prism 800 is used to deviate light emitted in the first beam direction 110 at the output side 220 of the taper 200 in the direction of the third two-dimensional image generator 2500. To this end, the prism 800 has an interface 810 that totally reflects the light coming from the output side 220 of the taper 200 in the direction of the third two-dimensional image generator 2500.

At the third two-dimensional image generator 2500, the light coming from the prism 800 is reflected while being deviated by each image point formed respectively by a micromirror either in a second beam direction 820 back in the direction of the prism 800, or in a different direction. The light deviated in a different direction may, for example, be absorbed at an absorber. Light reflected in the second beam direction 820 to the prism 800, however, can pass through the prism 800, it striking the interface 810 at an angle at which total reflection does not occur. The light reflected by the third two-dimensional image generator 2500 in the second beam direction 820 is two-dimensionally modulated by the array of micromirrors.

Following the prism 800 in the second beam direction 820, the third lighting arrangement 30 again has an optical projection element 600 that projects the light reflected in the second beam direction 820 by the third two-dimensional image generator 2500 into an environment, of the third lighting arrangement 30, to be illuminated by the third lighting arrangement 30, for example, onto a road in the vicinity of a motor vehicle.

The first lighting arrangement 10, the second lighting arrangement 20 and the third lighting arrangement 30 may be used as headlamps, in particular as front headlamps, of a motor vehicle. This application requires merely emission of monochromatic light. This advantageously makes it possible to configure the first two-dimensional image generator 500 of the first lighting arrangement 10, the second two-dimensional image generator 1500 of the second lighting arrangement 20 and the third two-dimensional image generator 2500 of the third lighting arrangement 30 as monochromatic image generators. The image generators 500, 1500, 2500 can thus advantageously be configured particularly simply, robustly, compactly and inexpensively. Another advantage of monochromatic image generators 500, 1500, 2500 is that they lead only to low light losses.

The light sources 100 of the first lighting arrangement 10, of the second lighting arrangement 20 and the third lighting arrangement 30 also advantageously need to generate only monochromatic light when the lighting arrangements 10, 20, 30 are used as headlamps of a motor vehicle so that the light sources 100 can also be configured simply, compactly and inexpensively.

The two-dimensional image generators 500, 1500, 2500 of the first lighting arrangement 10, of the second lighting arrangement 20 and the third lighting arrangement 30 may respectively have the same resolutions in both mutually perpendicular spatial directions. The individual image points (pixels) of the two-dimensional image generators 500, 1500, 2500 may, for example, be configured with a square shape. It is, however, also possible respectively to configure the two-dimensional image generators 500, 1500, 2500 with different resolutions in the two mutually perpendicular spatial directions. The image points of the two-dimensional image generators 500, 1500, 2500 may, for example, be configured with a square and non-square shape.

When the lighting arrangements 10, 20, 30 are used as adaptive headlamps of a motor vehicle, it may, for example, be favorable to configure the two-dimensional image generators 500, 1500, 2500 with a higher resolution in the vertical direction than in the horizontal direction, for example, with a resolution which is at least two times, or preferably at least three times, as high. The vertical direction in this case refers to that direction of the two-dimensional image generator 500, 1500, 2500 corresponding to the direction away from the motor vehicle in the projection through the optical projection element 600.

The two-dimensional image generators 500, 1500, 2500 of the first lighting arrangement 10, of the second lighting arrangement 20 and the third lighting arrangement 30 may respectively have constant resolutions over their entire surface. In this case, the individual image points of the two-dimensional image generators 500, 1500, 2500 are all of equal size. It is, however, also possible to configure the two-dimensional image generators 500, 1500, 2500 of the lighting arrangements 10, 20, 30 with variable resolutions over their surface. In this case, the image points of the two-dimensional image generators 500, 1500, 2500 may, for example, have different sizes in central regions of the two-dimensional image generators 500, 1500, 2500 than in outer regions of the two-dimensional image generators 500, 1500, 2500. In particular, the image points of the two-dimensional image generators 500, 1500, 2500 may have smaller sizes in the central regions of the two-dimensional image generators 500, 1500, 2500 than in the outer regions of the two-dimensional image generators 500, 1500, 2500 so that there is a higher resolution in the central regions. When the lighting arrangements 10, 20, 30 are used as headlamps of a motor vehicle, central regions of the illumination generated by the lighting arrangements 10, 20, 30 can be varied more finely than edge regions of the illumination generated by the lighting arrangements 10, 20, 30.

It is also possible to configure the light-emitting diodes 2110, arranged as a two-dimensional array, of the light-emitting diode light source 2100 of the first lighting arrangement 10, of the second lighting arrangement 20 and the third lighting arrangement 30 with different sizes in the two spatial directions or with variable sizes over the surface of the two-dimensional array. For example, the light-emitting diodes 2110 may have a smaller size and a higher density in the vertical direction of the two-dimensional array of light-emitting diodes 2110 of the light-emitting diode light source 2100 than in the horizontal direction. In addition or as an alternative, the light-emitting diodes 2110 may have a smaller size and a higher density in the central region of the two-dimensional array of the light-emitting diode light source 2100 than in outer regions of the two-dimensional array of the light-emitting diode light source 2100.

It is possible that, during operation 2100 of the first lighting arrangement 10, of the second lighting arrangement 20 and the third lighting arrangement 30, not all light-emitting diodes of the two-dimensional array of light-emitting diodes 2110 of the light-emitting diode light source 2100 are in operation simultaneously. This may be the case in particular when the first lighting arrangement 10, the second lighting arrangement 20 and the third lighting arrangement 30 are used as headlamps, in particular as front headlamps, of a motor vehicle. In this case, depending on a current driving situation of the motor vehicle, different adaptive illumination of an environment of the motor vehicle may be generated for which different parts of the two-dimensional array of light-emitting diodes 2110 of the light-emitting diode light source 2100 are used, but all light-emitting diodes of the light-emitting diode light source 2100 are never used simultaneously. This makes it possible to dimension an electricity supply of the light-emitting diode light source 2100 such that it is never capable of supplying all the light-emitting diodes of the light-emitting diode light source 2100 simultaneously. In this way, the electricity supply can be configured particularly compactly, inexpensively and economically.

My arrangements have been illustrated and described in detail with the aid of the preferred examples. This disclosure is nevertheless not restricted to the examples disclosed. Rather, other variants may be derived therefrom by those skilled in the art without departing from the protective scope of the appended claims.

This application claims priority of DE 10 2013 215 374.0, the disclosure of which is hereby incorporated by reference.

1.-19. (canceled)

20. A lighting arrangement comprising:
a light source,
a taper,
and a two-dimensional image generator,
wherein the taper guides light from the light source to the two-dimensional image generator, and
the lighting arrangement is configured as a motor vehicle headlamp.

21. The lighting arrangement as claimed in claim 20, wherein the light source comprises a laser diode.

22. The lighting arrangement as claimed in claim 20, wherein the light source comprises a light-emitting diode.

23. The lighting arrangement as claimed in claim 20, further comprising a diaphragm arranged between the light source and the taper,
wherein a side of the diaphragm facing toward the taper has mirroring.

24. The lighting arrangement as claimed in claim 20, further comprising a converter material that converts the wavelength of electromagnetic radiation.

25. The lighting arrangement as claimed in claim 20, further comprising a polarization-dependently reflecting sheet arranged in the optical beam path of the lighting arrangement between the taper and the two-dimensional image generator.

26. The lighting arrangement as claimed in claim 25, further comprising a retardation plate arranged in the optical beam path of the lighting arrangement between the taper and the polarization-dependently reflecting sheet.

27. The lighting arrangement as claimed in claim 26, wherein the retardation plate is configured to rotate a polarization of light passing through the retardation plate by 45°.

28. The lighting arrangement as claimed in claim 20, wherein the two-dimensional image generator is configured as a liquid-crystal arrangement.

29. The lighting arrangement as claimed in claim 28, wherein the two-dimensional image generator is configured as a monochromatic liquid-crystal arrangement.

30. The lighting arrangement as claimed in claim 28, wherein the two-dimensional image generator is configured as a transparent liquid-crystal arrangement.

31. The lighting arrangement as claimed in claim 28, wherein the two-dimensional image generator is configured as a reflecting liquid-crystal arrangement.

32. The lighting arrangement as claimed in claim 31, further comprising a polarization beam splitter arranged in the optical beam path of the lighting arrangement between the taper and the two-dimensional image generator.

33. The lighting arrangement as claimed in claim 20, wherein the two-dimensional image generator is configured as a micromirror arrangement.

34. The lighting arrangement as claimed in claim 33, further comprising a prism arranged in the optical beam path of the lighting arrangement between the taper and the two-dimensional image generator.

35. The lighting arrangement as claimed in claim 20, further comprising an optical projection element arranged downstream of the two-dimensional image generator in the optical beam path of the lighting arrangement.

36. The lighting arrangement as claimed in claim 20, wherein the two-dimensional image generator has a higher resolution in a first spatial direction than in a second spatial direction.

37. The lighting arrangement as claimed in claim 20, wherein the two-dimensional image generator comprises image points of different size.
